(19) United States
(12) Patent Application Publication
(10) Pub. No.: US 2022/0232036 A1
(43) Pub. Date: Jul. 21, 2022

(54) SYSTEMS AND METHODS FOR PROVIDING SOCIAL ENGINEERING AND MALWARE ALERTS

(71) Applicant: JPMORGAN CHASE BANK , N.A., New York, NY (US)

(72) Inventor: Goran LONCARIC, Plano, TX (US)

(21) Appl. No.: 17/648,053

(22) Filed: Jan. 14, 2022

Related U.S. Application Data
(60) Provisional application No. 63/138,065, filed on Jan. 15, 2021.

(51) Int. Cl. H04L 9/40

(52) U.S. Cl. CPC H04L 63/1483; H04L 63/145; H04L 63/1466

(57) ABSTRACT

Systems and methods for providing social engineering and malware alerts are disclosed. According to one embodiment, a method for providing in-application alerts may include: (1) receiving, at a computer program and from an operating system executed by a user electronic device, a notification that a message was received by the user electronic device and a caller ID for the message and/or a message sender identifier; (2) comparing, by the computer program, the caller ID for the message and/or the message sender identifier to data in one or more database; (3) determining, by the computer program, that the message is suspicious based on the comparison; (4) identifying, by the computer program, an activity being conducted using the user electronic device within a predetermined period of time from receipt of the message; and (5) issuing, by the computer program, a warning that the activity may be suspicious.

### RELATED APPLICATIONS

This application claims priority to, and the benefit of, U.S. Provisional Patent Application Ser. No. 63/138,065, filed Jan. 15, 2021, the disclosure of which is hereby incorporated, by reference, in its entirety.

### BACKGROUND OF THE INVENTION

### 1. Field of the Invention

The present disclosure generally relates to systems and methods for providing social engineering and malware alerts.

### 2. Description of the Related Art

One of the most common fraud attack vectors in the digital space is social engineering. For example, a fraudster may call or message a customer and convince the customer to disclose the customer's personal identification information (“PII”), the customer's username, passwords, one-time passcodes, etc., or to provide the fraudster with an opportunity to install malware, provide backdoor access or to conduct a transaction (e.g., add a new recipient, issue a payment to that recipient, etc.), etc. Social Engineering attacks are most likely done over a phone call where a fraudster has the highest chance to convince a customer to do something that will be to the customer's detriment and the fraudster's benefit.

Today, Mobile Network Operators (MNO) provide various solutions to alert the customer to potentially fraudulent calls. Some allow blocking of suspicious calls. These alerts/blocking functions can be paid services and are only as good as the mobile network operator's capability to detect potentially fraudulent calls. Most customers are not adequately protected/alerted of potentially fraudulent calls and are vulnerable to scams done via social engineering.

### SUMMARY OF THE INVENTION

Systems and methods for providing social engineering and malware alerts are disclosed. According to one embodiment, a method for providing in-application alerts may include: (1) receiving, at a computer program and from an operating system executed by a user electronic device, a notification that a message was received by the user electronic device and a caller ID for the message and/or a message sender identifier; (2) comparing, by the computer program, the caller ID for the message and/or the message sender identifier to data in one or more database; (3) determining, by the computer program, that the message is suspicious based on the comparison; (4) identifying, by the computer program, an activity being conducted using the user electronic device within a predetermined period of time from receipt of the message; and (5) issuing, by the computer program, a warning that the activity may be suspicious.

In one embodiment, the message may include a telephone call, a SMS message, an email, or a push notification.

In one embodiment, the method may also include receiving, by the computer program and from a third party, a notification that the message is suspicious.

In one embodiment, the third party may be an email provider, an internet service provider (ISP), and/or a mobile network operator.

In one embodiment, the activity may include making a payment to an unknown entity and/or installing suspected malware on the user electronic device.

In one embodiment, the method may also include: requesting, by the computer program, additional verification to execute the activity; receiving, by the computer program, the additional verification; and executing, by the computer program, the activity.

In one embodiment, the method may also include receiving, by the computer program, approval to execute the activity and executing, by the computer program, the activity.

According to another embodiment, a method for providing in-application alerts may include: (1) receiving, at a computer program executed by a backend and from a user electronic device, a notification that a message was received by the user electronic device and a caller ID for the message and/or a message sender identifier; (2) comparing, by the computer program, the caller ID for the message and/or the message sender identifier to data in one or more database; (3) determining, by the computer program, that the message is suspicious based on the comparison; (4) identifying, by the computer program, an activity being conducted using the user electronic device within a predetermined period of time from receipt of the message; and (5) issuing, by the computer program, a warning to the user electronic device that the activity may be suspicious.

In one embodiment, the message may be a telephone call, a SMS message, an email, or a push notification.

In one embodiment, the activity may include making a payment to an unknown entity and/or installing suspected malware on the user electronic device.

In one embodiment, the method may also include: requesting, by the computer program, additional verification to execute the activity; receiving, by the computer program, the additional verification; and executing, by the computer program, the activity.

In one embodiment, the additional verification may be received in an out-of-band communication.

In one embodiment, the method may also include receiving, by the computer program, approval to execute the activity and executing, by the computer program, the activity.

According to another embodiment, a method for providing in-application alerts may include: (1) receiving, at a computer program executed by a backend and from a user electronic device, a transaction request from a user, the transaction request involving a transaction with a transaction recipient; (2) querying, by the computer program, a third party with contact information for the transaction recipient; (3) receiving, by the computer program and from the third party, a suspicious score for the transaction recipient; (4) determining, by the computer program, that the third party is suspicious based on the suspicious score; (5) determining, by the computer program, that the user has been in contact with the transaction recipient; and (6) requiring, by the computer program, additional verification from the user to execute the transaction.

In one embodiment, the transaction may include making a payment to the transaction recipient or sending money to the transaction recipient.

In one embodiment, the third party may be a mobile network operator, an internet service provider, etc.

In one embodiment, the backend may be a backend for a financial institution, a backend for a cash transfer service, etc.

In one embodiment, the additional verification may be received in an out-of-band message.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 illustrates a system for in-application alerts according to one embodiment;

FIG. 2 depicts a method for providing in-application alerts according to one embodiment;

FIG. 3 depicts a method for providing in-application alerts according to another embodiment;

FIG. 4 depicts a method for providing in-application alerts according to another embodiment; and

FIG. 5 depicts a method for providing in-application alerts according to another embodiment.

### DETAILED DESCRIPTION OF PREFERRED EMBODIMENTS

Embodiments may include a computer program or application that may protect users from social engineering attacks reviewing calls that are received on a mobile electronic device. Embodiments may leverage an existing iOS/Android functionality that may be integrated into the computer program, which may be an existing computer program.

For example, the computer program may source a list, or lists, of phone numbers, email addresses, device identifiers, etc. that are associated with scammers from mobile network operators, third party vendors that specialize in collecting caller IDs associated with fraudulent activities, user inputs, combinations thereof, etc. The computer program would then receive, using the existing iOS/Android functionality, a notification of an incoming call to the mobile electronic device. If the computer program determines that the call is associated with a phone number and/or caller ID that is associated with likely fraudulent activity, the computer program would alert the user that the call is likely fraudulent activity, and remind the user not to give away any PII, passwords, etc. to the caller.

In one embodiment, the alert may be provided to an agent, an authorized or designated representative, etc.

For example, the notification from the operating system may “wake up” the computer program, and the message that is provided may be an in-application (“in-app”) notification. The type of in-application notification may be configurable by the user.

Because the warning is based on the computer program, and not the MNO, the users of the computer program will be protected regardless of the MNO that they use.

Should the user attempt to conduct a transaction that may appear to be related to the call (e.g., a high-risk transaction, sending money to an unknown phone number, etc.) within a certain period of receiving the call, the computer program may warn the user that the transaction has been identified as potentially being related to the potentially fraudulent activity call. The computer program may require additional authentication, acknowledgement from the user, etc. before allowing the transaction to proceed.

Thus, embodiments protect users from financial scams more effectively as the alert is shown not only when the call is received, but also within a predetermined period of time, to remind the user of the suspected scam call and to cause the user to rethink any suspicious transaction in the context of the warning.

Embodiments may provide a feedback loop (e.g., users may report and classify a scam as a financial scam involving a certain product), which enhances the ability to protect users of that product.

In embodiments, incoming messages, including SMS messages, emails, push messages, etc. may also be monitored. If the source and/or the contents of the message are suspicious (e.g., from a known scammer, contains language associated with a scam, etc.), the computer program may provide a warning to the user, and may also warn the user from conducting a suspicious transaction.

In embodiments, the computer program may provide information on the potential scam to a backend, which may be used in fraud/risk mitigation strategies. For example, a notification that the user received a suspicious call may be added to the customer's profile that may be accessed by customer service representatives.

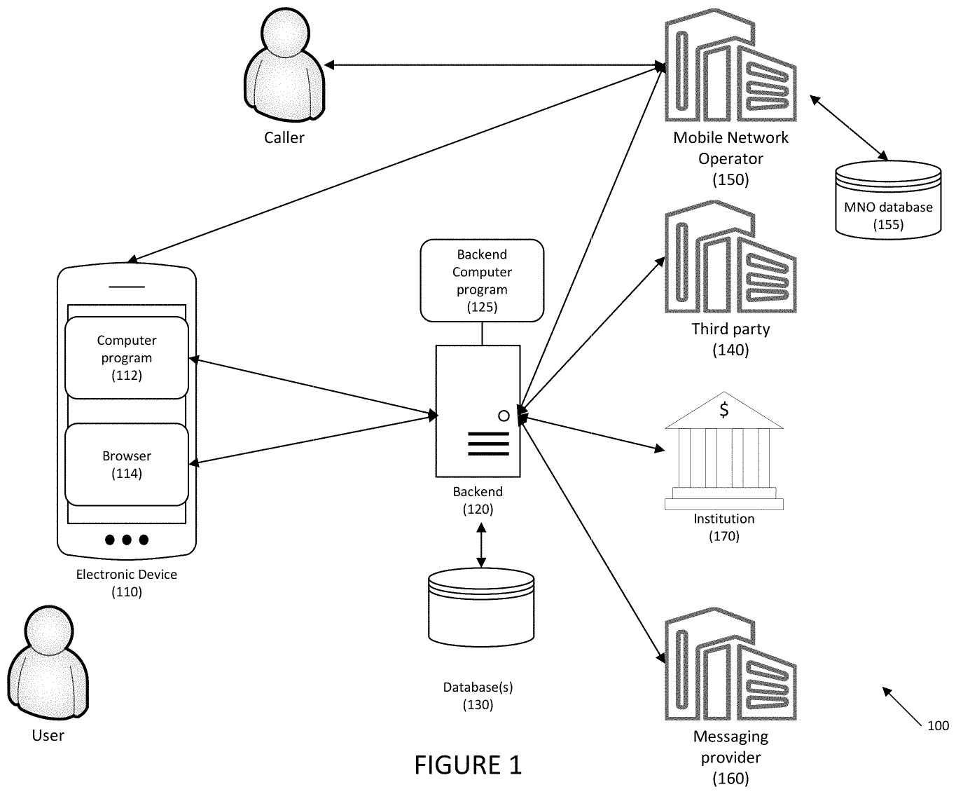

Referring to FIG. 1, a system for providing in-application alerts is provided according to an embodiment. System 100 may include electronic device 110, such as a smart phone, an Internet of Things (IoT) appliance, a smart watch, a computer, etc. Electronic device 110 may be capable of receiving phone calls, messages (e.g., text messages, emails, push messages, etc.).

Electronic device 110 may execute computer program 112, such as a mobile computer application, or app, and/or browser 114. Computer program 112 and/or browser 114 may interface with backend 120, which may receive communications from computer program 112 and/or browser 114. In one embodiment, backend 120 may be provided by or associated with institution 170, such as a financial institution, a FinTech entity, a consortium, or any other suitable entity.

Backend 120 may execute backend computer program 125.

Backend computer program 125 may communicate with one or more database 130. In one embodiment, database(s) may maintain a list of phone numbers, email addresses, device identifiers, senders, etc. that are associated with scammers. The list may be received from one or more mobile network operator 150, third parties 140 such as aggregators, from user input, etc.

In one embodiment, third party 140 may further include internet service providers, messaging providers, aggregator services (e.g., crowd sourcing of scam numbers, etc.), etc.

In one embodiment, database(s) 130 may include data related to known scams, such as message text, attachments, links, etc.

In one embodiment, database(s) 130 may include an allowed list of approved phone numbers, email addresses, device identifiers, etc. that are known to not be scams, or that the user has confirmed not to be scams, etc.

In one embodiment, database(s) 130 may further include an identification of known malware (e.g., phishing apps, logging apps, etc.).

In one embodiment, the content of database(s) 130 may be generated and/or updated using, for example, machine learning.

In one embodiment, backend computer program 125 and/or computer program 112/browser 114 may scan incoming calls, messages (e.g., email, SMS), and/or other signals received by electronic device 110, or an application executed thereon (e.g., an email app, a texting app, etc.), for risk assessment. In embodiments, this scanning may be performed with user consent.

In one embodiment, messaging provider 160 may provide one or more signals to backend computer program 125 that the user has received a suspicious email or message, whether the email or message involves suspected or known malware, etc.

In embodiments, backend computer program 125 and/or computer program 112/browser 114 may store the incoming signals (e.g., calls, messages, etc.) and may provide alerts (e.g., in-application alerts). Embodiments may interject a process into a high-risk flow to require acknowledgment from the user before proceeding with the high-risk flow.

Mobile network operator 150 may be a provider of telecommunication and/or data services to the user. In one embodiment, a caller may call the user via mobile network operator 150, and mobile network operator 150 may capture the caller's caller ID or other identification. In one embodiment, mobile network operator 150 may maintain MNO database 155 of phone numbers, device identifiers, etc. associated with fraudulent activities.

In one embodiment, mobile network operator 150 may generate a caller risk score associated with the caller. In one embodiment, the caller risk score may be based on whether a caller identifier (e.g., callerID, device ID, SIM card ID, etc.) is present in MNO database 155, etc.

In addition to caller ID, mobile network operator 150 may use SIM card-related data from a SIM card use in electronic device 110 to calculate the caller risk score. For example, mobile network operator 150 may look at geolocation logs to identify unlikely movement velocity (e.g., sudden movements between serving cell tower thousands of miles apart), tenure (e.g., recently issued SIMs are higher risk), etc. As another example, mobile network operator 150 may source potential scam signals from third party 140, such as a database of crowd-reported suspicious calls.

For calling devices that are not part of mobile network operator 150's network (e.g., the phone numbers or SIM card numbers are part of a different mobile network), mobile network operator 150 may request information from the mobile network operator for the second network, and that information may be used to calculate a confidence score.

In embodiments, mobile network operator 150 may generate the caller risk score based on whether the callerID, SIM card identifier, etc. are present on mobile network operator 150's internal scam list and also receives information from third party 140 that indicates that increases a confidence level that the caller is a scam. Third parties 140 may also have their own gradations of scam likely scores based on the number of reports from their users (e.g., ten users reporting a callerID as being a scammer versus 1000 users reporting a callerID as being a scammer within 24 hours). The caller risk score may allow a nuanced approach on how to deal with the problem—drop the transaction altogether or request the user provide additional info to confirm they are not being scammed.

In one embodiment, institution 170 may be a financial institution, FinTech, money transfer entity, merchant, etc. that may receive the caller risk score from backend 120 and may apply restrictions or additional screening before allowing an activity. For example, institution 170 may apply rules before allowing a transaction to occur, such as a payment, money transfer, purchase, etc.

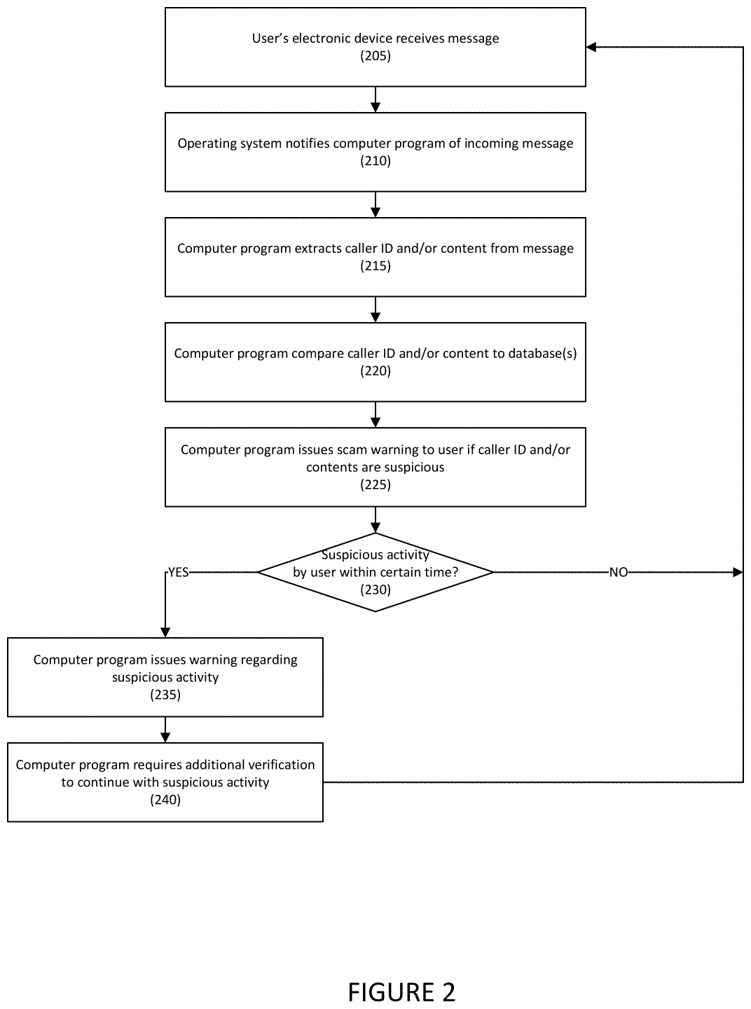

Referring to FIG. 2, a method for providing in-application alerts is provided according to an embodiment.

In step 205, a user electronic device may receive a message. In one embodiment, the message may be a telephone call, a SMS message, an email, a push notification, etc.

In step 210, the operating system for the electronic device may notify a computer program that the message has been received. In one embodiment, one or more Application Programming Interfaces (APIs) may be used to provide the notification to the computer program. Exemplary APIs include APIs include Android's CallScreeningService( ) that scans calls, Android's SmSMessage( ) that provides information on SMS messages to the computer program, Android's getInstalledApplications( ) that provides information on other applications installed on the electronic device and may compare that to database of known malware apps. Other APIs may be used as is necessary and/or desired.

In one embodiment, the API may provide at least some of the following information to the computer program: caller ID, message originator, message subject, message contents, time of message, etc.

In one embodiment, a third party, such as an email provider, an internet service provider (ISP), mobile network operator, etc. may provide a signal or notification that the user has received a suspicious message. In one embodiment, the notification may be received by the backend and may include the user's registered messaging address, and may receive a classification of the suspicious message (e.g., phishing, money transfer, etc.) so that the proper warning may be provided. The actual content of the suspicious message may not be provided.

For example, the third party and/or the API may provide an indication whether the message is suspicious, an indication whether the message is related to malware (e.g., another application that is known to be a phishing/malware app), etc. Other suitable indicators may be provided as is necessary and/or desired.

In step 215, the computer program may extract certain information from the message or any information that may be provided separately. For example, the caller ID, message originator, message subject, message contents, time of message, may be extracted as is necessary and/or desired.

In step 220, the computer program may compare the caller ID, message originator, message originator's address, and/or message content against data that may be stored in one or more databases of phone numbers, device identifiers, email addresses, and/or message content that are known to be sources of scams, or contain content that is associated with a scam (e.g., message content, links, etc.).

In step 225, the computer program may issue a warning if the caller id, message originator, message contents, etc. are identified as suspicious based on the comparison. In one embodiment, the message may be an in-app message, a push message, etc. Other types of messages may be provided as is necessary and/or desired.

In step 230, the computer program may identify a suspicious activity that the user is attempting to conduct using the electronic device within a certain period of receiving the message. For example, the user may attempt to navigate to a website, call a phone number, make a payment to an unknown entity, launch an application, install or access suspected malware, etc. within a certain amount of time following the message. A non-limiting exemplary time period is 15 minutes. If such activity is identified or detected, in step 235, the computer program may issue a warning via, for example, a push message, reminding the user of the potentially fraudulent message. Should the user wish to continue with the suspicious activity, in step 240, the computer program may require additional verification from the user before allowing the user to continue, such as re-authenticating to the electronic device and/or the computer program, entering a password or passcode, etc. If the user is successful, the user will be permitted to continue.

In one embodiment, the user may be required to acknowledge receipt of the warning.

In one embodiment, based on the completion of the activity, the user may have an approved list of phone numbers, email addresses, device identifiers, etc. The next time a message from the same source is received, the warnings may be bypassed.

In one embodiment, suspicious activity may be tracked and displayed to a customer service representative at an entity, such as a financial institution, a cash transfer service, a merchant, etc. for further manual verification. For example, if the user receives a call or message from a caller purporting to be the United States Marshall to pay a certain sum or be arrested, that activity may be saved. If the user goes to withdraw funds from a bank, send money using a cash transfer service, etc. within a certain amount of time (e.g., within two hours) of the call or message, the customer service representative may be presented with instructions to ask the user additional questions, such as asking whether they have been asked to send money to someone, etc. Additional confirmation from the user may be required before the transaction is permitted.

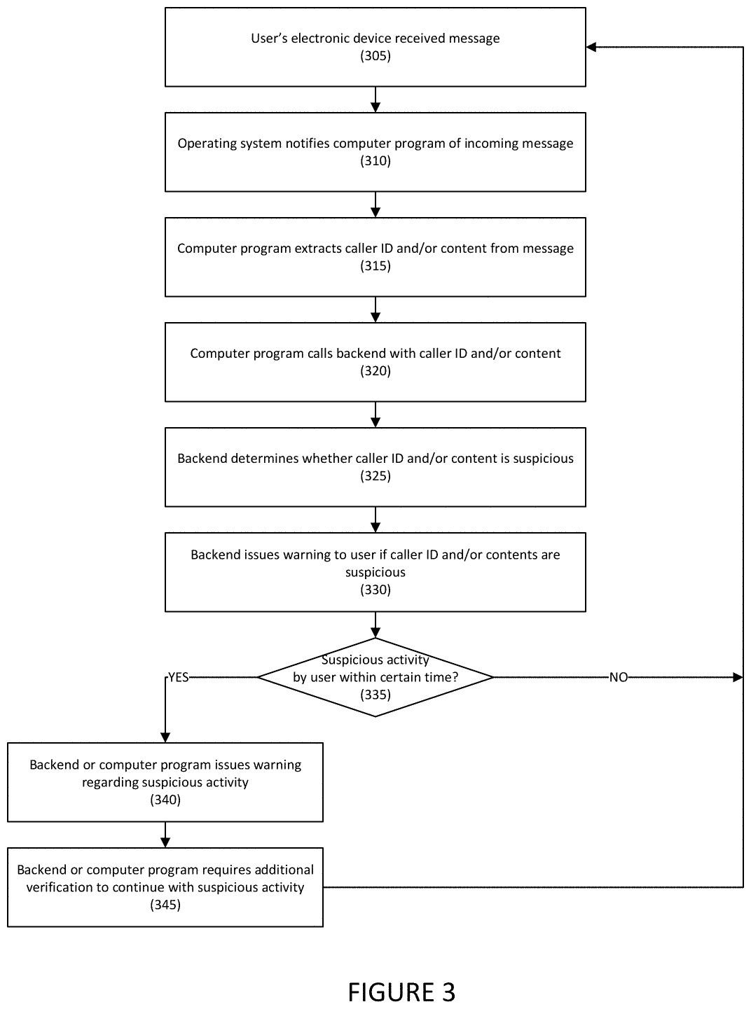

Referring to FIG. 3, a method for providing in-application alerts is provided according to another embodiment.

In step 305, a user electronic device may receive a message. This may be similar to step 205, above.

In step 310, the operating system for the electronic device may notify a computer program that the message has been received. This may be similar to step 210, above.

In step 315, the computer program may extract certain information from the message or any information that may be provided separately. This may be similar to step 215, above.

In step 320, the computer program may call a backend with the caller ID and/or message content. For example, the computer program may call a backend for a financial institution, a third party (e.g., an internet service provider, a mobile network operator, an aggregator, etc.) with the caller ID and/or message content.

In step 325, the backend may determine whether the caller ID and/or content is suspicious. For example, the backend may compare the caller ID and/or the message content against data that may be stored in one or more databases of phone numbers, email addresses, device identifiers, and/or message content that are known to be sources of scams, or contain content that is associated with a scam (e.g., message content, links, etc.).

In step 330, the backend may issue a warning to user if the caller ID and/or the message contents are suspicious. For example, the backend may push a message to the user electronic device by SMS, in-app messaging, etc.

In step 335, the computer program and/or backend may identify a suspicious activity that the user is attempting to conduct using the electronic device within a certain period of receiving the message. For example, the user may attempt to navigate to a website, call a phone number, make a payment to an unknown entity, send money to an unknown entity, launch an application, install or access suspected malware, etc. within a certain amount of time following the message. A non-limiting exemplary time period is 15 minutes. If such activity is identified or detected, in step 340, the backend or the computer program may issue a warning via, for example, a push message, reminding the user of the potentially fraudulent message. Should the user wish to continue with the suspicious activity, in step 345, the backend or the computer program may require additional verification from the user before allowing the user to continue, such as re-authenticating to the electronic device and/or the computer program, entering a password or passcode, etc. If the user is successful, the user will be permitted to continue.

In one embodiment, the message and/or additional verification requirement may be provided to an entity, such as a bank, merchant, cash transfer service, etc.

In one embodiment, the user may be required to acknowledge receipt of the warning.

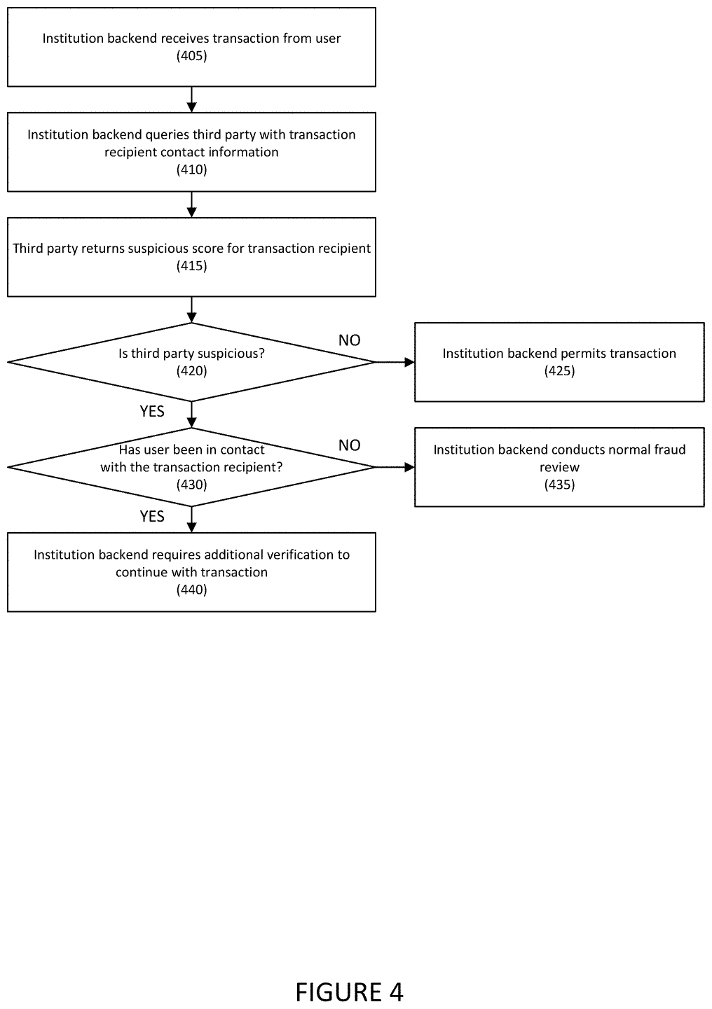

Referring to FIG. 4, a method for providing in-application alerts is provided according to another embodiment.

In step 405, an institution backend, such as that for a financial institution, may receive a transaction from user. For example, the institution may receive a transaction initiated by the user's electronic device. The transaction may identify a transaction recipient by, for example, email, phone number, address, etc.

In step 410, the institution backend may query a third party with transaction recipient contact information. For example, the third party may be an aggregator, an internet service provider, a mobile network operator, etc. In one embodiment, the institution backend may query the third party using an API.

In step 415, the third party may generate and return a suspicious score for the transaction recipient. For example, the third party may compare the transaction recipient contact information to data that may be stored in one or more databases of phone numbers, device identifiers, email addresses, and/or other contact information that are known to be sources of scams, or contain content that is associated with a scam (e.g., message content, links, etc.).

In step 420, if the suspicious score from the third party indicates that the transaction recipient is not suspicious (e.g., the suspicious score is below a threshold), in step 425, the institution backend may permit the transaction.

If the suspicious score indicates that the transaction is suspicious, in step 430, the institution backend may determine whether the user has been in contact with the transaction recipient, such as receiving an email, phone call, etc. If not, in step 435, the institution backend may conduct a normal fraud review.

If the user has been in conduct with the transaction recipient, in step 440, the institution backend may additional verification to continue with transaction. For example, the institution backend may require the user to re-authenticate to the electronic device and/or the computer program, enter a password or passcode, etc. If the user is successful, the user will be permitted to continue.

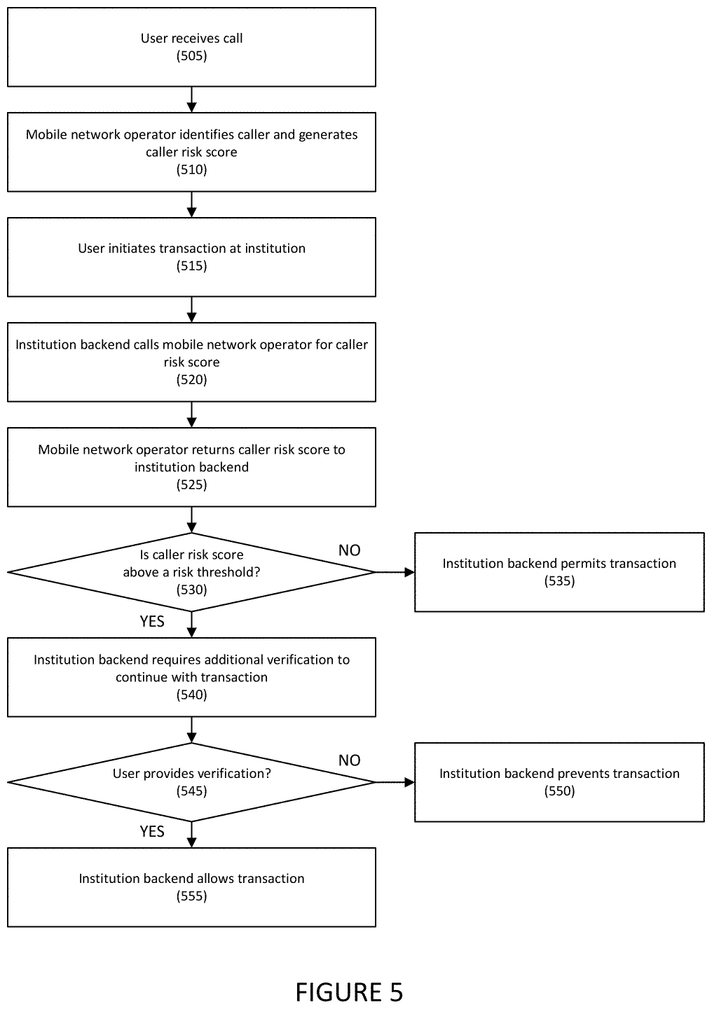

Referring to FIG. 5, a method for providing in-application alerts is provided according to another embodiment.

In step 505, a user may receive a call or a message from another entity. For example, the call or message may be routed through, for example, a mobile network operator.

In step 510, the mobile network operator may identify the caller or sender, and may generate a caller risk score. For example, the mobile network operator may compare the caller or sender, or message content (if available) to data that may be stored in one or more databases of phone numbers, device identifiers, and/or other contact information that are known to be sources of scams, or contain content that is associated with a scam (e.g., message content, links, etc.).

In step 515, the user may initiate a transaction at an institution, such as a financial institution, a merchant, a cash transfer service, etc. The transaction may be any suitable transaction involving a transaction recipient, such as an individual, a merchant, etc.

In step 520, the institution's backend may call the mobile network operator for the caller risk score. In one embodiment, the institution's backend may use an API to call the mobile network operator.

In step 525, the mobile network operator may return the caller risk score to the institution's backend. The caller risk score may be provided in any suitable format.

In step 530, the institution's backend may compare the caller risk score to a risk threshold. If the caller risk score is below a risk threshold, in step 535, the institution's backend may permit the transaction.

If the caller risk score is above the caller risk score, in step 540, the institution's backend may require additional verification from the user to continue with transaction. For example, the institution's backend may require the user to re-authenticate to the electronic device and/or the computer program, enter a password or passcode, etc. If the user is successful, the user will be permitted to continue.

In step 545, the institution's backend may determine whether the user provides the additional verification. If the user does not provide such verification, in step 550, the institution's backend may prevent the transaction. If the user provides the verification, in step 555, the institution's backend may allow the transaction.

It should be noted that these steps are exemplary only, and certain steps may be combined, reordered, modified, etc. as is necessary and/or desired.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for providing in-application alerts, comprising:
receiving, at a computer program and from an operating system executed by a user electronic device, a notification that a message was received by the user electronic device and a caller ID for the message and/or a message sender identifier;
comparing, by the computer program, the caller ID for the message and/or the message sender identifier to data in one or more database;
determining, by the computer program, that the message is suspicious based on the comparison;
identifying, by the computer program, an activity being conducted using the user electronic device within a predetermined period of time from receipt of the message; and
issuing, by the computer program, a warning that the activity may be suspicious.

2. The method of claim 1, wherein the message comprises a telephone call, a SMS message, an email, or a push notification.

3. The method of claim 1, further comprising:
receiving, by the computer program and from a third party, a notification that the message is suspicious.

4. The method of claim 3, wherein the third party comprises an email provider, an internet service provider (ISP), and/or a mobile network operator.

5. The method of claim 1, wherein the activity comprises making a payment to an unknown entity and/or installing suspected malware on the user electronic device.

6. The method of claim 1, further comprising:
requesting, by the computer program, additional verification to execute the activity;
receiving, by the computer program, the additional verification; and
executing, by the computer program, the activity.

7. The method of claim 1, further comprising:
receiving, by the computer program, approval to execute the activity; and
executing, by the computer program, the activity.

8. A method for providing in-application alerts, comprising:
receiving, at a computer program executed by a backend and from a user electronic device, a notification that a message was received by the user electronic device and a caller ID for the message and/or a message sender identifier;
comparing, by the computer program, the caller ID for the message and/or the message sender identifier to data in one or more database;
determining, by the computer program, that the message is suspicious based on the comparison;
identifying, by the computer program, an activity being conducted using the user electronic device within a predetermined period of time from receipt of the message; and
issuing, by the computer program, a warning to the user electronic device that the activity may be suspicious.

9. The method of claim 8, wherein the message comprises a telephone call, a SMS message, an email, or a push notification.

10. The method of claim 8, wherein the activity comprises making a payment to an unknown entity and/or installing suspected malware on the user electronic device.

11. The method of claim 8, further comprising:
requesting, by the computer program, additional verification to execute the activity;
receiving, by the computer program, the additional verification; and
executing, by the computer program, the activity.

12. The method of claim 11, wherein the additional verification is received in an out-of-band communication.

13. The method of claim 8, further comprising:
receiving, by the computer program, approval to execute the activity; and
executing, by the computer program, the activity.

14. A method for providing in-application alerts, comprising:
receiving, at a computer program executed by a backend and from a user electronic device, a transaction request from a user, the transaction request involving a transaction with a transaction recipient;
querying, by the computer program, a third party with contact information for the transaction recipient;
receiving, by the computer program and from the third party, a suspicious score for the transaction recipient;
determining, by the computer program, that the third party is suspicious based on the suspicious score;
determining, by the computer program, that the user has been in contact with the transaction recipient; and
requiring, by the computer program, additional verification from the user to execute the transaction.

15. The method of claim 14, wherein the transaction comprises making a payment to the transaction recipient or sending money to the transaction recipient.

16. The method of claim 14, wherein the third party comprises a mobile network operator.

17. The method of claim 14, wherein the third party comprises an internet service provider.

18. The method of claim 14, wherein the backend is a backend for a financial institution.

19. The method of claim 14, wherein the backend is a backend for a cash transfer service.

20. The method of claim 14, wherein the additional verification is received in an out-of-band message.
